(19) United States
(12) Patent Application Publication
(10) Pub. No.: US 2024/0308312 A1
(43) Pub. Date: Sep. 19, 2024

(54) CARGO BED COVER FOR A VEHICLE

(71) Applicant: Fargo Tonneau LLC, West Fargo, ND (US)

(72) Inventors: Jayce M. Gravdahl, Wichita, KS (US); Andrew Gravdahl, Moorhead, MN (US)

(21) Appl. No.: 18/183,896

(22) Filed: Mar. 14, 2023

(51) Int. Cl. B60J 7/16

(52) U.S. Cl. CPC B60J 7/1614

(57) ABSTRACT

A cargo bed cover for a cargo bed includes an inner support mountable within the cargo bed; a cap movable between a retracted position in which the cap is received at least partially into the cargo bed and around the inner support and an extended position in which the cap extends at least partially above the inner support; a frame mountable to the cap; a telescoping structure mountable to the frame and the inner support; and a drive operable to move the cap between the retracted position and the extended position.

### BACKGROUND

The present disclosure relates to vehicle accessories, and more particularly to cargo bed covers.

A variety of structures are utilized to cover a truck bed area such as tonneau covers, camper shells, bed covers, etc. Oftentimes, installation and removal of such covers may be time consuming and labor intensive.

### SUMMARY

A cargo bed cover for a cargo bed according to one disclosed non-limiting embodiment of the present disclosure includes an inner support mountable within the cargo bed; a cap movable between a retracted position in which the cap is received at least partially into the cargo bed and around the inner support and an extended position in which the cap extends at least partially above the inner support; a frame mountable to the cap; a telescoping structure mountable to the frame and the inner support; and a drive system mounted to the inner support and the frame, the drive system operable to move the cap between the retracted position and the extended position.

A further embodiment of any of the foregoing embodiments of the present disclosure includes, wherein the inner support fits within the cargo bed.

A further embodiment of any of the foregoing embodiments of the present disclosure includes, wherein the inner support is uniquely sized to the cargo bed.

A further embodiment of any of the foregoing embodiments of the present disclosure includes, wherein the inner support comprises a recess for each wheel well.

A further embodiment of any of the foregoing embodiments of the present disclosure includes a first side door mounted to the cap; a second side door mounted to the cap; and a rear door mounted to the cap.

A further embodiment of any of the foregoing embodiments of the present disclosure includes wherein the first side door and the second side door are each mounted to the cap via a sliding pivot.

A further embodiment of any of the foregoing embodiments of the present disclosure includes, wherein the sliding pivot is slidable along a track adjacent to a roof of the cap.

A further embodiment of any of the foregoing embodiments of the present disclosure includes, wherein the roof defines a perimeter greater than the cargo bed.

A further embodiment of any of the foregoing embodiments of the present disclosure includes, wherein the roof defines a perimeter greater than the inner support.

A further embodiment of any of the foregoing embodiments of the present disclosure includes, wherein the first side door, the second side door, and the rear door each include a window.

A further embodiment of any of the foregoing embodiments of the present disclosure includes a pillar that extends from each corner of the cap.

A further embodiment of any of the foregoing embodiments of the present disclosure includes, wherein the drive system comprises a powered jack.

A further embodiment of any of the foregoing embodiments of the present disclosure includes, wherein the drive system comprises a rod-less air slide.

A further embodiment of any of the foregoing embodiments of the present disclosure includes, wherein the drive system comprises a pneumatic cylinder.

A cargo bed cover for a cargo bed, according to one disclosed non-limiting embodiment of the present disclosure includes an inner support mountable within the cargo bed, the inner support fits within the cargo bed; a cap movable between a retracted position in which the cap is received at least partially into the cargo bed and around the inner support and an extended position in which the cap extends at least partially above the inner support, the cap comprises a roof that defines a perimeter greater than the inner support; a first side door mounted to the cap; a second side door mounted to the cap; a rear door mounted to the cap; a frame mountable to the cap; a telescoping structure mountable to the frame and the inner support; a first rod-less air slide mounted to a first side of the inner support and the frame; a second rod-less air slide mounted to the first side of the inner support and the frame; a third rod-less air slide mounted to a second side of the inner support and the frame; a fourth rod-less air slide mounted to the second side of the inner support and the frame, wherein the first, second, third, and fourth rod-less air slide are operable to move the cap between the retracted position and the extended position.

A further embodiment of any of the foregoing embodiments of the present disclosure includes a pillar that extends from each corner of the cap.

A further embodiment of any of the foregoing embodiments of the present disclosure includes, wherein the first side door, the second side door, and the rear door each include a window, the first side door and the second side door are each mounted to the cap via a sliding pivot that is slidable along a track adjacent to the roof of the cap.

A cargo bed cover for a cargo bed, according to one disclosed non-limiting embodiment of the present disclosure includes an inner support mountable within the cargo bed, the inner support fits within the cargo bed; a cap movable between a retracted position in which the cap is received at least partially into the cargo bed and around the inner support and an extended position in which the cap extends at least partially above the inner support, the cap comprises a roof that defines a perimeter greater than the inner support; a first side door mounted to the cap; a second side door mounted to the cap; a rear door mounted to the cap; a frame mountable to the cap; a telescoping structure mountable to the frame and the inner support; a first powered jack mounted to a first side of the inner support and the frame; and a second powered jack mounted to a second side of the inner support and the frame, the first and second powered jack operable to move the cap between the retracted position and the extended position.

A further embodiment of any of the foregoing embodiments of the present disclosure includes a pillar that extends from each corner of the cap.

A further embodiment of any of the foregoing embodiments of the present disclosure includes wherein the first side door, the second side door, and the rear door each include a window and the first side door and the second side door are each mounted to the cap via a sliding pivot that is slidable along a track adjacent to the roof of the cap.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is an exploded view of a cargo bed cover according to one disclosed non-limiting embodiment.

FIG. 2 is a perspective partial phantom view illustrating the cargo bed cover of FIG. 1 in a retracted position.

FIG. 3 is a perspective partial phantom view illustrating the cargo bed cover of FIG. 1 in an extended position.

FIG. 4 is a side partial phantom view illustrating the cargo bed cover of FIG. 1 in an extended position.

FIG. 5 is a top view illustrating the cargo bed cover of FIG. 1.

FIG. 6 is a rear partial phantom view illustrating the cargo bed cover of FIG. 1 with the side doors thereof in a partial open position.

FIG. 7 is a rear partial phantom view illustrating the cargo bed cover of FIG. 1 with the side doors thereof in an open and retracted position.

FIG. 8-9 are perspective partial phantom views illustrating the cargo bed cover of FIG. 1 in various positions between retraction and extension.

FIG. 10 is an exploded view of a cargo bed cover according to another disclosed non-limiting embodiment.

FIG. 11-14 are perspective partial phantom views illustrating the cargo bed cover of FIG. 10 in various positions from retraction to extension.

### DETAILED DESCRIPTION

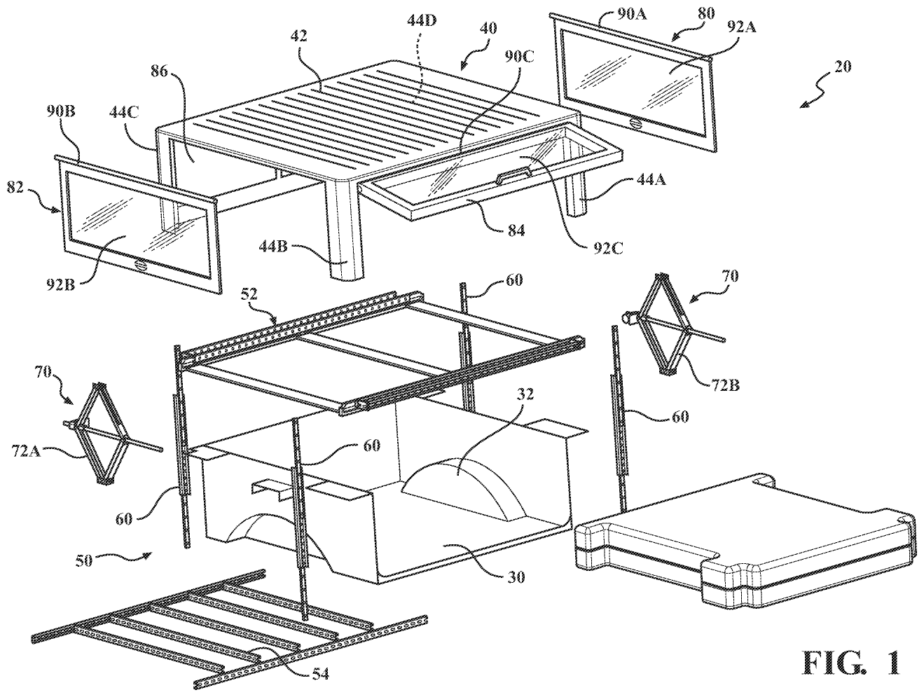

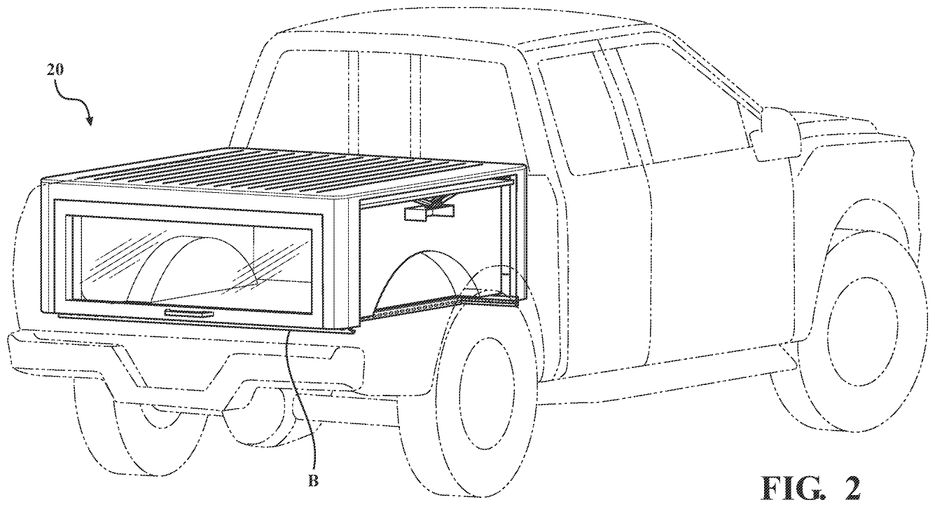

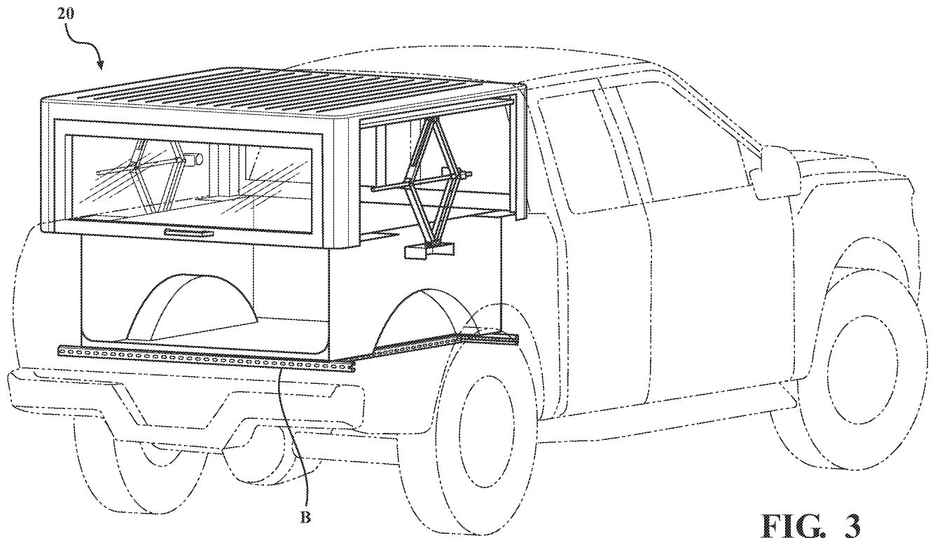

FIG. 1 schematically illustrates a cargo bed cover 20 that provides a powered conversion between a retracted position (FIG. 2) and an extended position (FIG. 3). The cargo bed cover 20 generally includes an inner support 30 mountable within the cargo bed B (FIGS. 2 and 3), a cap 40 movable between the retracted position (FIG. 2) and the extended position (FIG. 3), a frame 50, a telescoping structure 60 mountable to the frame 50 and the inner support 30, and a drive system 70. The cargo bed cover 20 provides essentially a tonneau cap in the retracted position (FIG. 2) and a load-bearing, lockable bed shell in the extended position (FIG. 3).

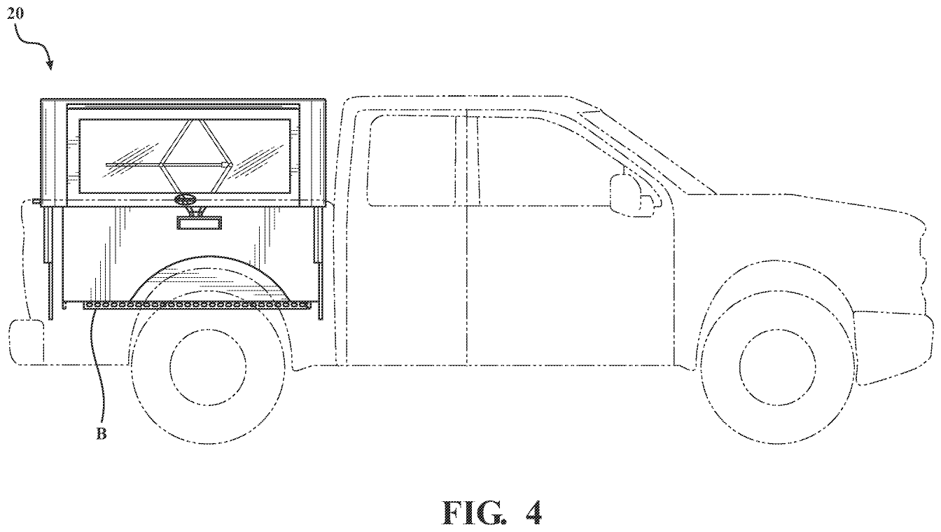

The inner support 30 fits within the cargo bed B. The inner support may be generic or uniquely sized to a particular cargo bed B (also shown in FIG. 4). That is, the inner support 30 may include a particular configuration for the cargo bed that may include, for example, a recess 32 that is received over each wheel well which typically extends into the cargo bed B. The inner support 30 may be manufactured of metal alloy or composite material. In one embodiment, the inner support 30 may be a sheet metal, or molded structure.

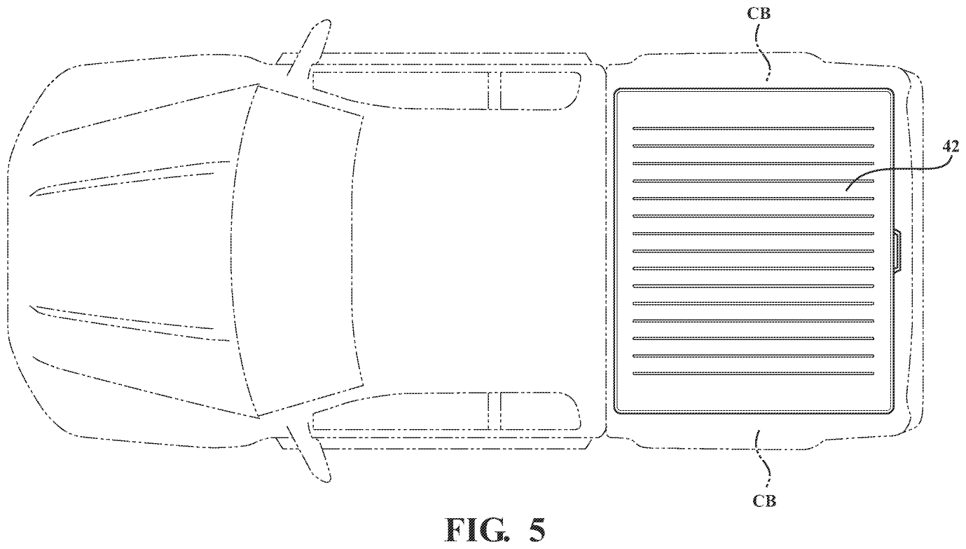

The cap 40 generally includes a roof 42 and a pillar 44A, 44B, 44C, 44D that extends from each corner of the roof 42. The roof 42 may define a perimeter greater than the cargo bed B and/or the inner support 30. That is, the roof 42 may rest at least partially on the inner support 30 or portions of the walls CB of the cargo bed B when in the retracted position (FIG. 5) to provide a significant load-bearing structure that permits cargo to be placed thereon. The roof 42 may include non-slip surfaces, tie-downs or other cargo handling structures.

Each pillar 44A, 44B, 44C, 44D forms a corner of the cap 40 to provide an interface for a first side door 80, a second side door 82, a rear door 84 and a forward wall 86. That is, the pillar 44A, 44B, 44C, 44D extends from the roof 42 of the cap 40 to form the cap. Various designs and configurations may be provided.

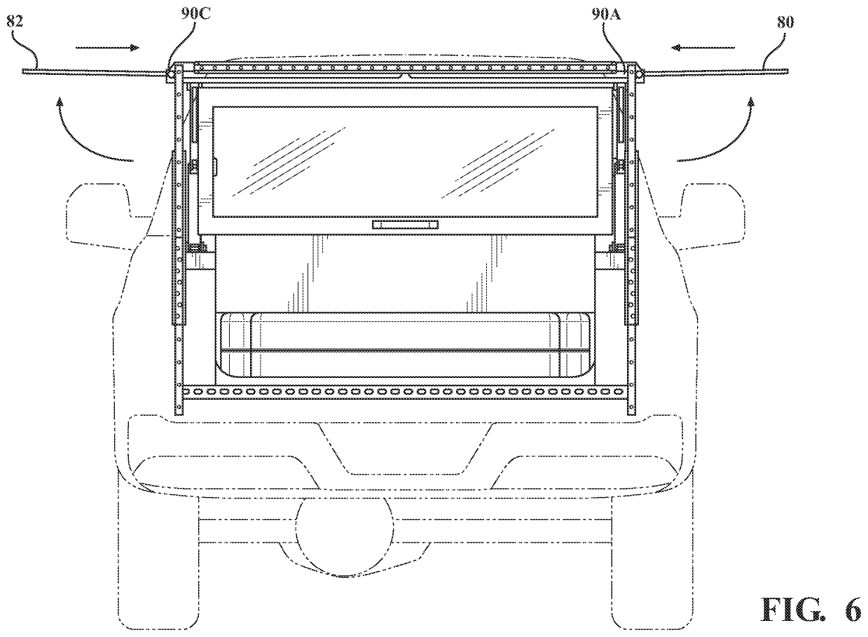

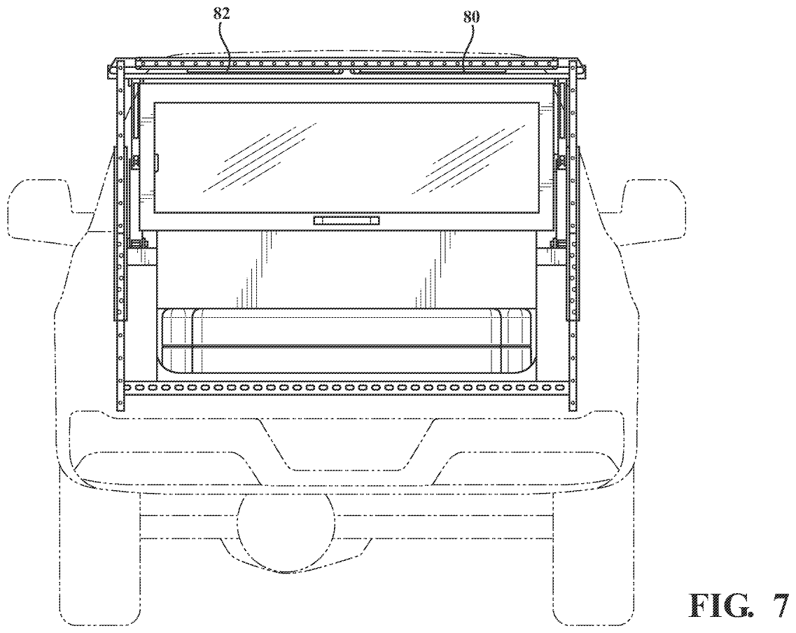

The first side door 80, the second side door 82, and the rear door 84 may each be mounted to the cap 40 via a sliding pivot 90A, 90B, 90C. The sliding pivot 90A, 90B, 90C is slidable along a track adjacent to the roof 42 of the cap 40. The first side door 80, the second side door 82, and the rear door 84 are thereby pivoted up then slid parallel to the roof 42 (FIGS. 6 and 7) such that the cap 40 may be moved into the retracted position (FIG. 2). In one embodiment, a window 92A, 92B, 92C in each door 80, 82, 84 is thereby protected when the cap 40 is in the retracted position (FIG. 2).

The frame 50 includes the telescoping structure 60 that supports the cap 40. The frame 50 and the telescoping structure 60 may be manufactured of various materials of applicability, including but not limited to aluminum, aluminum alloy, and stainless steel. The frame 50 may include a roof structure 52 and a bed structure 54 manufactured of, for example, strut channels that are interconnected by the telescoping structure 60 at each corner thereof. The telescoping structure 60 may include zinc-plated steel telescoping slides that support the roof structure 52 with respect to the bed structure 54. The frame 50 provides a load-bearing structure for the cap 40 which may be of a lighter weight and less structural material. In other words, the frame 50 may provide the load-bearing and the cap 40 provide the aesthetic outer shell.

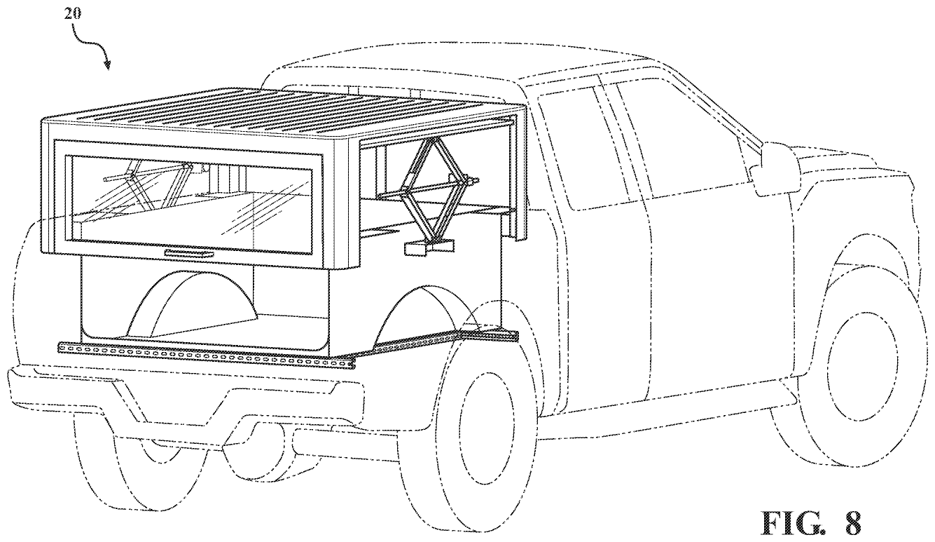

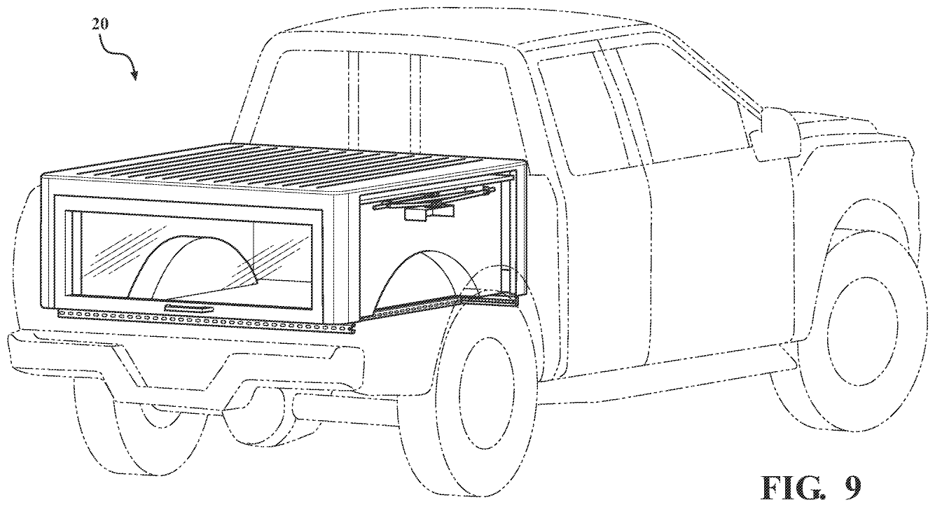

In one embodiment, the drive system 70 comprises a powered jack 72A, 72B along each side of the inner support 30. The powered jack 72A, 72B may be mounted to the inner support 30 and the roof structure 52 to provide powered movement (example partial movement shown in FIGS. 8 and 9) between the retracted position (FIG. 2) and the extended position (FIG. 3).

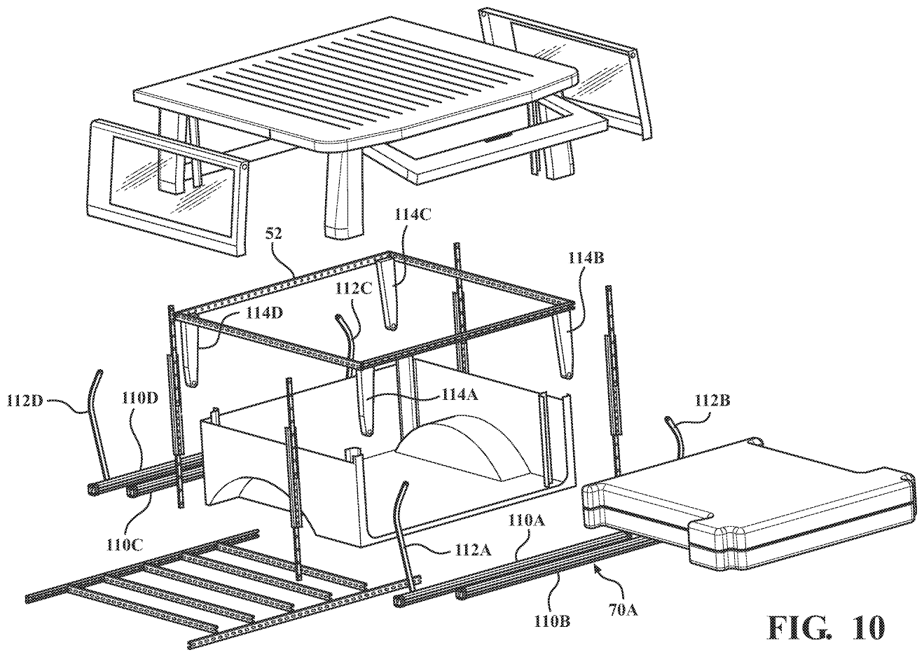

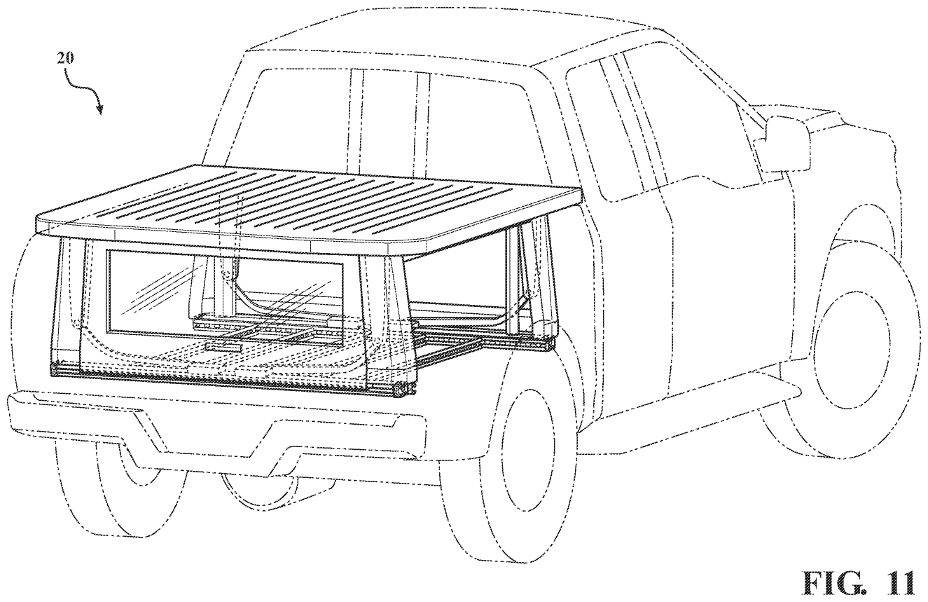

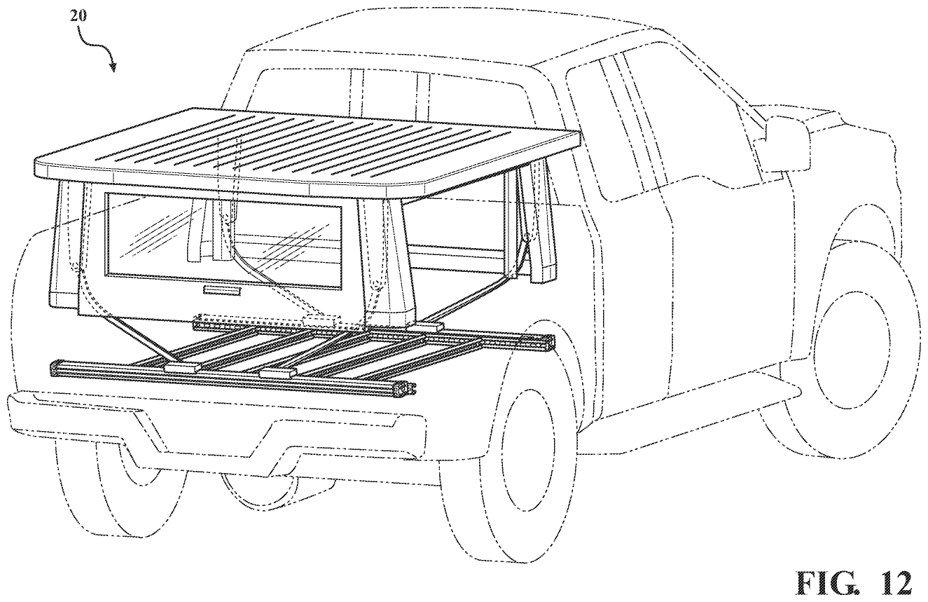

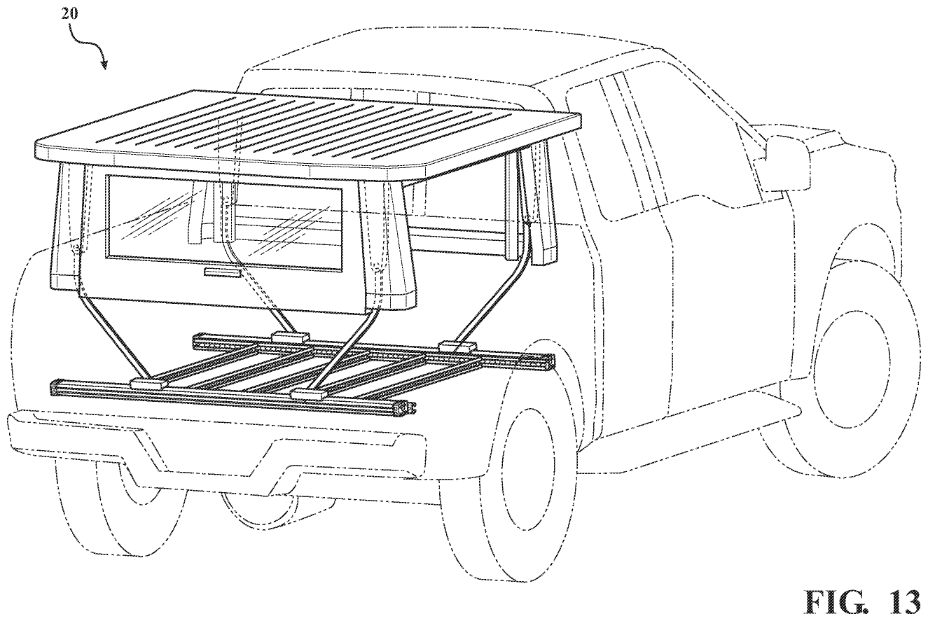

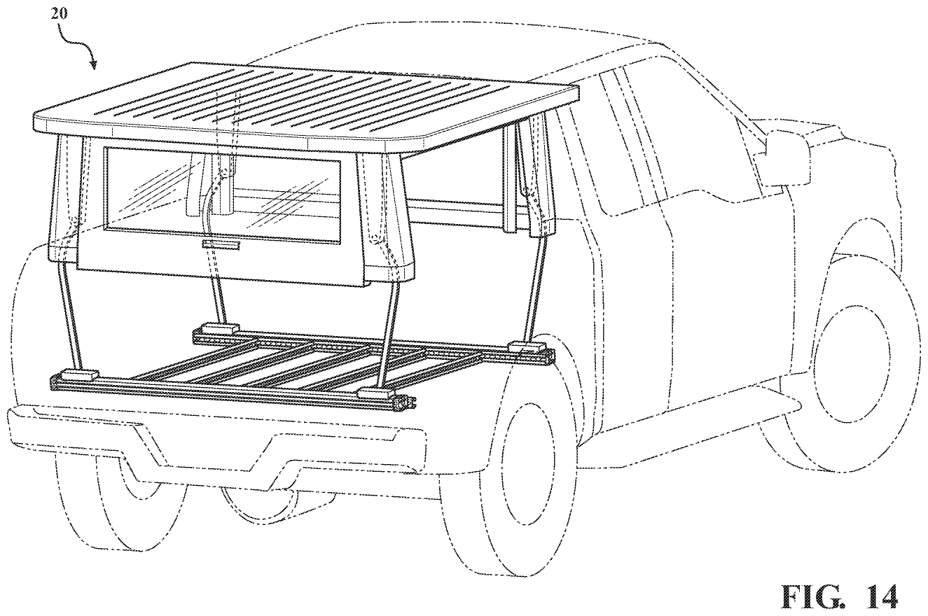

With reference to FIG. 10, in another embodiment, the drive system 70A may include a first and second rod-less air slide 110A, 110B mounted toward the rear of the inner support 30 and a third and fourth rod-less air slide 110C, 110D mounted toward the front of the inner support 30. Each rod-less air slide 110A, 110B, 110C, 110D drives a pushrod 112A, 112B, 112C, 112D attached to a support 114A, 114B, 114C, 114D that extends from the roof structure 52. With no external moving parts, the rod-less air slide 110A, 110B, 110C, 110D provide a long stroke, but have a static footprint as only a carriage moves. The rod-less air slide 110A, 110B, 110C, 110D have a magnetic piston which can be readily integrated with sensors to activate relays and controllers. The first, second, third, and fourth rod-less air slide 110A, 110B, 110C, 110D are operable to move the cap between the retracted position and the extended position (FIG. 11-14).

The cargo bed cover 20 allows for high load-bearing capabilities, allowing for bed mounting of snowmobiles, dirt bikes, tents, etc., and could be customizable by individual manufacturers.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

1. A cargo bed cover for a cargo bed, comprising:
an inner support mountable within the cargo bed;
a cap movable between a retracted position in which the cap is received at least partially into the cargo bed and around the inner support and an extended position in which the cap extends at least partially above the inner support;
a frame mountable to the cap;
a telescoping structure mountable to the frame and the inner support; and
a drive system mounted to the inner support and the frame, the drive system operable to move the cap between the retracted position and the extended position.

2. The cargo bed cover as recited in claim 1, wherein the inner support fits within the cargo bed.

3. The cargo bed cover as recited in claim 1, wherein the inner support is uniquely sized to the cargo bed.

4. The cargo bed cover as recited in claim 3, wherein the inner support comprises a recess for each wheel well.

5. The cargo bed cover as recited in claim 1, further comprising:
a first side door mounted to the cap;
a second side door mounted to the cap; and
a rear door mounted to the cap.

6. The cargo bed cover as recited in claim 5, wherein the first side door and the second side door are each mounted to the cap via a sliding pivot.

7. The cargo bed cover as recited in claim 6, wherein the sliding pivot is slidable along a track adjacent to a roof of the cap.

8. The cargo bed cover as recited in claim 7, wherein the roof defines a perimeter greater than the cargo bed.

9. The cargo bed cover as recited in claim 7, wherein the roof defines a perimeter greater than the inner support.

10. The cargo bed cover as recited in claim 5, wherein the first side door, the second side door, and the rear door each include a window.

11. The cargo bed cover as recited in claim 1, further comprising a pillar that extends from each corner of the cap.

12. The cargo bed cover as recited in claim 1, wherein the drive system comprises a powered jack mounted to the inner support.

13. The cargo bed cover as recited in claim 1, wherein the drive system comprises a rod-less air slide.

14. The cargo bed cover as recited in claim 1, wherein the drive system comprises a pneumatic cylinder.

15. A cargo bed cover for a cargo bed, comprising:
an inner support mountable within the cargo bed, the inner support fits within the cargo bed;
a cap movable between a retracted position in which the cap is received at least partially into the cargo bed and around the inner support and an extended position in which the cap extends at least partially above the inner support, the cap comprises a roof that defines a perimeter greater than the inner support;
a first side door mounted to the cap;
a second side door mounted to the cap;
a rear door mounted to the cap;
a frame mountable to the cap;
a telescoping structure mountable to the frame and the inner support;
a first rod-less air slide mounted to a first side of the inner support and the frame;
a second rod-less air slide mounted to the first side of the inner support and the frame;
a third rod-less air slide mounted to a second side of the inner support and the frame; and
a fourth rod-less air slide mounted to the second side of the inner support and the frame, wherein the first, second, third, and fourth rod-less air slide are operable to move the cap between the retracted position and the extended position.

16. The cargo bed cover as recited in claim 15, further comprising a pillar that extends from each corner of the cap.

17. The cargo bed cover as recited in claim 16, wherein the first side door, the second side door, and the rear door each include a window and the first side door and the second side door are each mounted to the cap via a sliding pivot that is slidable along a track adjacent to the roof of the cap.

18. A cargo bed cover for a cargo bed, comprising:
an inner support mountable within the cargo bed, the inner support fits within the cargo bed;
a cap movable between a retracted position in which the cap is received at least partially into the cargo bed and around the inner support and an extended position in which the cap extends at least partially above the inner support, the cap comprises a roof that defines a perimeter greater than the inner support;
a first side door mounted to the cap;
a second side door mounted to the cap;
a rear door mounted to the cap;
a frame mountable to the cap;
a telescoping structure mountable to the frame and the inner support;
a first powered jack mounted to a first side of the inner support and the frame; and
a second powered jack mounted to a second side of the inner support and the frame, the first and second powered jack operable to move the cap between the retracted position and the extended position.

19. The cargo bed cover as recited in claim 18, further comprising a pillar that extends from each corner of the cap.

20. The cargo bed cover as recited in claim 19, wherein the first side door, the second side door, and the rear door each include a window, the first side door and the second side door are each mounted to the cap via a sliding pivot that is slidable along a track adjacent to the roof of the cap.
